(19) United States
(12) Patent Application Publication
(10) Pub. No.: US 2024/0064555 A1
(43) Pub. Date: Feb. 22, 2024

(54) LAN-AWARE QUALITY OF SERVICE ORCHESTRATION

(71) Applicant: NEC Laboratories America, Inc., Princeton, NJ (US)

(72) Inventors: Srimat Chakradhar, Manalapan, NJ (US); Murugan Sankaradas, Dayton, NJ (US); Sandesh Dhawaskar Sathyanarayana, Boulder, CO (US)

(21) Appl. No.: 18/451,412

(22) Filed: Aug. 17, 2023

Related U.S. Application Data
(60) Provisional application No. 63/399,363, filed on Aug. 19, 2022.

(51) Int. Cl. H04W 28/02; H04L 45/302; H04W 28/24

(52) U.S. Cl. CPC H04W 28/0268; H04L 45/302; H04W 28/24

(57) ABSTRACT

Methods and systems for transmission over a heterogeneous network include determining a path through a first network, including collecting quality of service (QoS) parameters for network devices in the path. The QoS parameters of the network devices are configured to provide a predetermined QoS assurance across the path. A network flow is transmitted from a network slice of a second network through the first network, along the path.

### RELATED APPLICATION INFORMATION

This application claims priority to U.S. Patent Application No. 63/399,363, filed on Aug. 19, 2022, incorporated herein by reference in its entirety.

### BACKGROUND

### Technical Field

The present invention relates to network quality of service management and, more particularly, to ensuring quality of service over links that include modern and legacy network technologies.

### Description of the Related Art

Modern networking technologies provide for fine-grained quality of service assurances, for example using network slices to provide specific quality of service for different links. However, legacy network technologies are relatively coarse-grained, providing a limited number of quality of service levels. Additionally, existing mechanisms for providing quality of service assurances on legacy networks are often defined in a vendor-specific way, so that a particular network link may pass through multiple different regimes between its origin and its destination. When the link passes through such a regime, differences in quality of service definitions may result in a failure to maintain the quality of service assurances needed for the link.

### SUMMARY

A method for transmission over a heterogeneous network includes determining a path through a first network, including collecting quality of service (QoS) parameters for network devices in the path. The QoS parameters of the network devices are configured to provide a predetermined QoS assurance across the path. A network flow is transmitted from a network slice of a second network through the first network, along the path.

A system for transmission over a heterogeneous network includes a hardware processor and a memory that stores a computer program. When executed by the hardware processor, the computer program causes the hardware processor to determine a path through a first network, including collecting quality of service (QoS) parameters for network devices in the path, to configure the QoS parameters of the network devices to provide a predetermined QoS assurance across the path, and to transmit a network flow from a network slice of a second network through the first network, along the path.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a heterogeneous communications network that includes a radio access network and (RAN) a local area network (LAN), where quality of service (QoS) assurances from the RAN are translated to the LAN, in accordance with an embodiment of the present invention;

FIG. 2 is a block/flow diagram of identifying and configuring a path for a network flow through a LAN that maintains a QoS assurance from a RAN, in accordance with an embodiment of the present invention;

FIG. 3 is pseudo-code for network path discovery for a network flow from a RAN through a LAN, in accordance with an embodiment of the present invention;

FIG. 4 is pseudo-code for checking the feasibility of a network path through a LAN, in accordance with an embodiment of the present invention;

FIG. 5 is a block diagram of an orchestrator/controller system that can identify and configure a path for a network flow through a LAN that maintains a QoS assurance from a RAN, in accordance with an embodiment of the present invention; and

FIG. 6 is a block diagram of a computing device that can perform path discovery, path feasibility checks, and LAN device configuration, in accordance with an embodiment of the present invention.

### DETAILED DESCRIPTION OF PREFERRED EMBODIMENTS

Modern networking technologies, such as 5G local area networks (5GLAN), provide fine-grained quality of service (QoS) using network slicing. In contrast, legacy local area networks (LAN) uses a relatively coarse mechanism to provide QoS, with a limited number of hardware queues in a LAN device that are each allocated a certain percentage of the bandwidth of an outgoing path. Such devices may use differentiated services code points (DSCPs) to tag packet headers for particular QoS assurances.

When information from a radio access network (RAN) enters a LAN, the fine-grained QoS information is not retained, breaking QoS for the slice. Even if DSCP information is set at the origin within the LAN, transit across multiple LAN devices can further break QoS for the stream, as each device may have a different definition of how DSCP tags correspond to queues of different respective priorities.

However, orchestration of QoS of network flows from the RAN, over a LAN, is still possible. Toward that end, an end-to-end path of the network flow is identified through the heterogeneous network. The queues and corresponding DSCP values for devices along the path are identified. If a common and acceptable DSCP value is found through the entire path, then that DSCP value is used to create a network flow with adequate QoS assurances for the information being transmitted. If not, the LAN devices along the path may be automatically reconfigured with rewrite rules to ensure that the network flow can maintain the level of service needed.

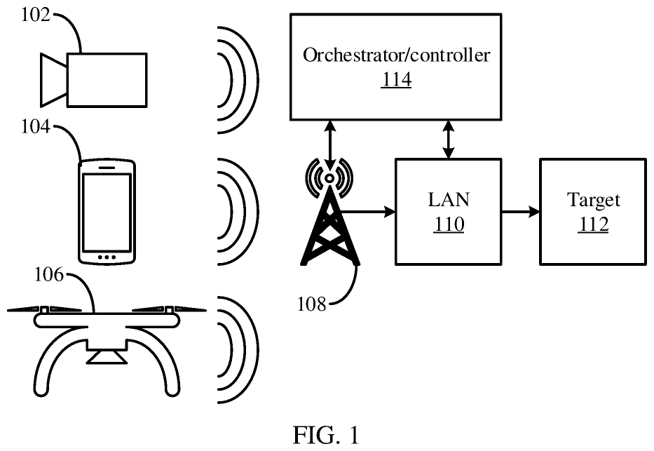

Referring now to FIG. 1, a diagram of a heterogeneous network is shown. The network includes one or more user equipment devices, which may for example include video cameras 102, smartphones 104, and/or unmanned aerial vehicles 106. It is contemplated that the user equipment device(s) may include any appropriate device hat transmits information wirelessly to a RAN 108. Thus, the user equipment device(s) may include internet of things (IoT) devices that have one or more onboard sensors and that report information from their sensors. Other examples of user equipment devices include devices that receive input from users and that perform network operations, such as searches for information, responsive to user inputs.

The RAN 108 may be, for example, a 5G network that connects wirelessly to the user equipment devices. The RAN 108 may provide network slices to the user equipment devices to ensure QoS is maintained. A network slice may be a dedicated physical or virtual resource that provides, for example, assurances of bandwidth and latency for network connections that use it.

For example, an unmanned aerial vehicle 106 may need a relatively high quality of service, as real-time video is transmitted to an operator and as the operator transmits instructions back. A loss of QoS can result in a failure of the unmanned aerial vehicle 106 and potentially loss or damage. In contrast, a smartphone 104 may need a relatively low quality of service for some types of information, such as web browsing, but may need a relatively high quality of service for a video chat. The RAN 108 identifies the QoS needs for a given network flow and assigns the network flow to an appropriate network slice.

However, the network flow may need to cross a LAN 110 to reach a destination 112. For example, the destination may be an end user, an analytics system, a remote server, or any other appropriate device to receive the network flow. The LAN 110 may include a variety of network devices, including routers and switches, that conduct information in the network flow from the RAN 108 to the destination 112. These LAN devices may include different hardware and software configurations that relate to QoS over the LAN 110.

For example, LAN 110 may include devices with different hardware capabilities, each having a respective number of hardware queues. The hardware queues are assigned different respective percentages of the LAN device's outgoing bandwidth. Each queue in a LAN device may be assigned to a type of traffic class, such as audio, video, network control, real-time audio, real-time video, etc. This relatively coarse-grained assignment of traffic classes contrasts to the QoS provisions of the RAN's network slices, with each flow getting a respective guaranteed bit rate (GBR).

In the example of a video stream, multiple different RAN slices may accommodate video streams, each with different QoS needs, each entering the LAN 110. At the LAN 110, they may all be considered a single type of traffic (e.g., “video”), where they would compete with one another for space in the corresponding queue.

A network orchestrator/controller 114 works with the RAN 108 and the LAN 110 to identify a path through the LAN 110 and to select DSCP values that may be used to ensure appropriate QoS for respective network flows. The orchestrator/controller 114 inspects the path used for available queues to discover the network path and port details of devices in the LAN 110. Available queues and DSCP values are identified. If a common DSCP value is found along the path, slices may be orchestrated to use that DSCP value. If not, rewrite instructions may be used to create a DSCP path through the LAN 110.

Once a slice is launched, the queues and network path are monitored for changes. If a path cannot be determined, or if an existing path changes in a way that cannot be recovered, a notice may be generated that QoS will be broken. The notice may include information relating to the particular LAN device and port that creates a bottleneck for the network flow.

One reason that QoS can break in a flow across the LAN 110 is a mismatch in the available queues from one LAN device to the next and the DSCP markings associated with them. The available queues may vary, for example, across switches, while the marking to place packets into those queues is based on mapping tables. For example, a switch may have eight queues, associated DSCP values as shown in Table 1.

TABLE 1

| DSCP values | Queue number |
|---|---|
| 0-7 | 1 |
| 8-15 | 2 |
| 16-23 | 3 |
| 24-31 | 4 |
| 32-39 | 5 |
| 40-47 | 6 |
| 48-55 | 7 |
| 56-63 | 8 |

DSCP values may be mismatched for a network flow across multiple L3 LAN devices. In one example, the first switch may allocate 35% of its bandwidth to queue number 8, while a second switch that follows the first switch in the network flow's path allocates a similar amount in its queue number 1. These two queues are compatible with the network flow, in that they can provide sufficient bandwidth to accommodate the network flow's needs. However, the queue in the first switch is associated with DSCP values 56-63, while the queue in the second switch is associated with DSCP values 8-15.

Packets that arrive at a switch with a DSCP value that correspond to an unavailable queue may be put into a default queue, where they will compete with other flows and fail to meet QoS assurances. Because queues may be provisioned with different capacities in different switches, marking data from a 5GLAN with a DSCP code may not be sufficient to ensure QoS is maintained.

Some networks include both L2 and L3 switches. L2 switches use three bits of a Class of Service (CoS) field to classify packets into queues and uses a DSCP mapping table to translate DSCP bits into CoS bits, and CoS bits into a queue number. If the mismatch occurs in this translation, packets can end up in the wrong queue, breaking CoS.

Packets arrive at ingress ports of a LAN device before being placed in a forwarding queue. Packets arriving at the device from directly connected hosts may be given a higher priority than network flows from RAN 108. If packets come from such a host, packets from the RAN may be dropped before being placed in dedicated queues. The packets in a LAN device may be drained from a queue based on the queue's priority and queue number.

LAN devices may include two policies that govern queue draining. A strict policy continuously drains the packets from higher-priority queues until they are empty, before moving to lower-priority queues. A round-robin policy drains packets in a round-robin fashion based on the queues' dedicated bandwidths. If the policy is set to strict, RAN packets may be dropped as high-priority queues are served and low-priority queues fill up. The LAN devices may therefore be set to round-robin to avoid breaking QoS for RAN flows.

QoS translation in the LAN 110 may be achieved using dedicated queues, but the availability of these queues is based on LAN traffic. For example, local LAN traffic may completely fill any or all of the queues available at a given LAN device. QoS for a 5GLAN flow across the LAN 110 may break if the RAN flows do not take the local LAN flows into account.

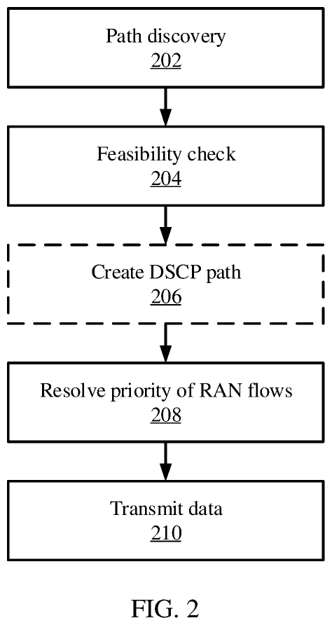

Referring now to FIG. 2, a method of orchestration for transmitting 5GLAN flows over a LAN 110. The orchestrator/controller 114 performs path discovery to find the network devices from the RAN 108 to the LAN 110, including ingress and egress port-level details. This may be performed using network address resolution protocol (ARP) and internet protocol (IP) tables that govern routing logic. If network nodes are accessed from a software defined network (SDN) controller, then the path can be accessed from the controller. Devices in the LAN 110 may be accessed directly by IP or by an SDN controller, and an initial edge router that connects the RAN 108 and the LAN 110 is identified. Additional detail on the process of path discovery is provided below.

Once the network path is identified, including LAN devices and port details, the same LAN devices are used to determine queue status. A feasibility check 204 is performed based on current LAN and RAN flows to determine whether the current queue configuration will support the QoS needed for a RAN flow through the LAN 110. Additional detail on the feasibility check 204 is provided below.

The feasibility check may determine that the DSCP marking is different across different LAN devices or between L2 and L3. Once the DSCP configuration of all LAN devices in the path is collected, a determination can be made as to whether the existing DSCP configuration is suitable. If so, then the 5GLAN flow can be implemented using the current DSCP configuration. If not, block 206 creates a DSCP path through the LAN 110. In particular, rewrite rules may be installed in the LAN devices, for example from (Rᵢₙᵢₜ₊₁+1, Pₒᵤₜ) to (R_{end},Pₒᵤₜ) with DSCP definitions of the LAN devices being set to (Rᵢₙᵢₜ₊₁, dscp).

DSCP rewrite rules may be used to modify the DSCP value of a packet. The DSCP value is a six-bit field in the packet's header that is used to indicate the packet's priority. By modifying the DSCP value, the rewrite rule can influence how a packet is handled by routers and switches in the network. To do this, the rewrite rule matches the packet to a forwarding class. The forwarding class is a three-bit filed in the header that is used to identify the type of traffic that the packet belongs to. Once the packet has been matched to a forwarding class, the rewrite rule modifies the DSCP value.

Rewrite rules can be used to improve the performance of certain types of traffic, such as voice or video traffic. They can also be used to improve network security by marking certain types of traffic as sensitive or confidential. For example, a rewrite rule may be used to ensure that voice traffic is forwarded with a high priority.

Rᵢ refers to the i^{th} LAN device in the network path, with Rᵢₙᵢₜ referring to the first LAN device in the network path and with R_{end} referring to the final LAN device in the network path. A path Pᵢ is defined as a sequence of tuples (Rᵢ, Pᵢₙ, Pₒᵤₜ) that starts at Rᵢₙᵢₜ and ends at R_{end}, with Pᵢₙ identifying an ingress port and Pₒᵤₜ identifying an egress port for the respective LAN devices.

In some circumstances, RAN flows can take lower priority than local LAN flows that arrive at a LAN device from a direct connection. To avoid this problem, block 208 resolves the priority of RAN flows across the network path. Ingress port reservation can be used for all ingress ports of a LAN device along the network path using a two-rate three-color approach. Two-rate defines the minimum and maximum rate, while three-color refers to a packet drop scheme. The minimum rate may be defined as rateₘᵢₙ=min({gbr₁, gbr₂, . . . , gbr_{f}}) and the maximum rate may be defined as rateₘₐₓ=max({gbr₁, gbr₂, . . . , gbr_{f}}), for all x∈{pᵢₙ, Rᵢ} and Rᵢ∈path, where pᵢₙ is an input port and Rᵢ is an index of the router along the path where the traffic flows. GBR represents the guaranteed bitrate for a flow that guarantees a minimum bandwidth. The draining policy for the queues may be set to be a round-robin policy at egress ports across the network path.

The two-rate, three-color scheme may meter a traffic stream based on a committed information rate (CIR), a committed burst size (CBS), a peak information rate (PIR), and a peak burst size (PBS). The CIR represents a bandwidth limit for guaranteed traffic, the CVS represents the maximum packet size permitted for bursts of data that exceed the CIT, the PIR represents the bandwidth limit for peak traffic, and the PBS represents the maximum packet size permitted for bursts of data that exceed the PIR. The scheme classifies traffic as belonging to one of three color categories: green, yellow and red.

Green traffic conforms to the bandwidth limit and burst size for guaranteed traffic. Yellow traffic exceeds the bandwidth limit or burst size for guaranteed traffic, but not the bandwidth limit and burst size for peak traffic. Red traffic exceeds the bandwidth and burst size for peak traffic. For green traffic, two-rate three-color policing marks the packets with an implicit loss priority of “low” and transmits the packets. For yellow traffic, the two-rate three-color policing marks the packets with an implicit loss priority of medium-high and transmits the packets. For red traffic, the two-rate three-color policing marks the packets with an implicit loss priority of high and may optionally discard the packets. If congestion occurs downstream, packets with higher loss priority are more likely to be discarded.

Block 210 then derives the LAN flows. Details of the flows may be collected, with header details including a type of service (ToS) field. The LAN flows in each queue of interest in the network path are identified. The DSCP values of the queues in the LAN devices may be determined from the ToS field of LAN packets, and the number of LAN flows through each queue may be determined to verify the feasibility of queues as described in greater detail below.

Using the information about the LAN flows, the current utilization of different queues in the network can be determined. This information can be used to place RAN traffic in appropriate queues. For example, collecting LAN flow data makes it possible to calculate the current utilization of each queue, dividing the number of packets in the queue by the queue's capacity. High-priority RAN traffic can be placed in queues that are relatively empty.

Once a final path through the LAN 110 has been determined, with any configuration changes, block 212 transmits data from the RAN 108 through the LAN 110, to a destination 112.

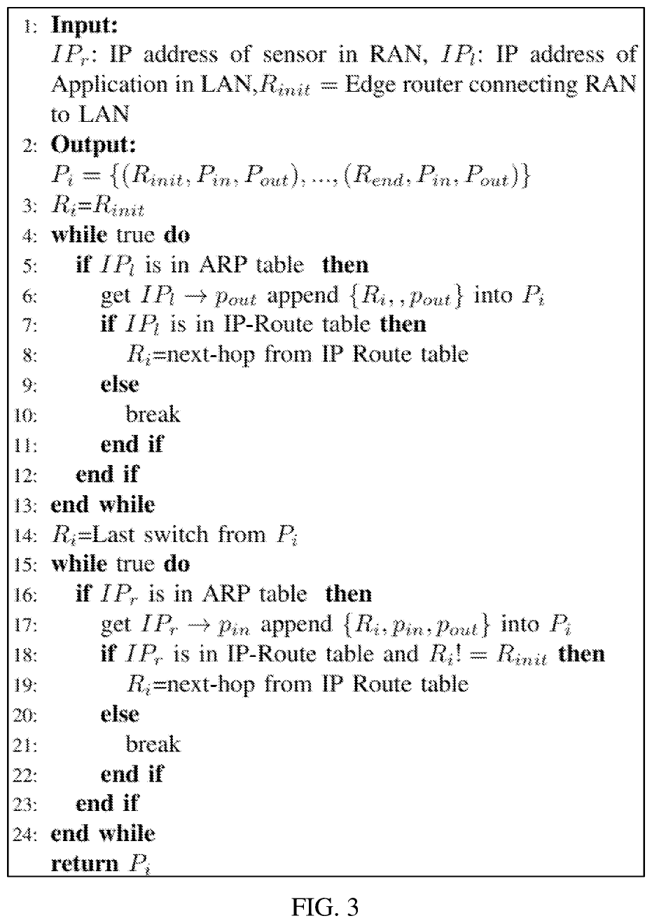

Referring now to FIG. 3, pseudo-code is provided that implements network path discovery. The initial router is determined and its ARP table is examined. This obtains the egress port for a flow through the initial router, which is added to the path along with the IP address of the initial router. The process is repeated for subsequent hops in the network path, with IP and port information being added to the path. The process is then repeated in the opposite direction, starting with the last LAN device in the path, to identify ingress ports and add them to the path. This process can be repeated periodically to identify changes in the path and to update any pertinent port information.

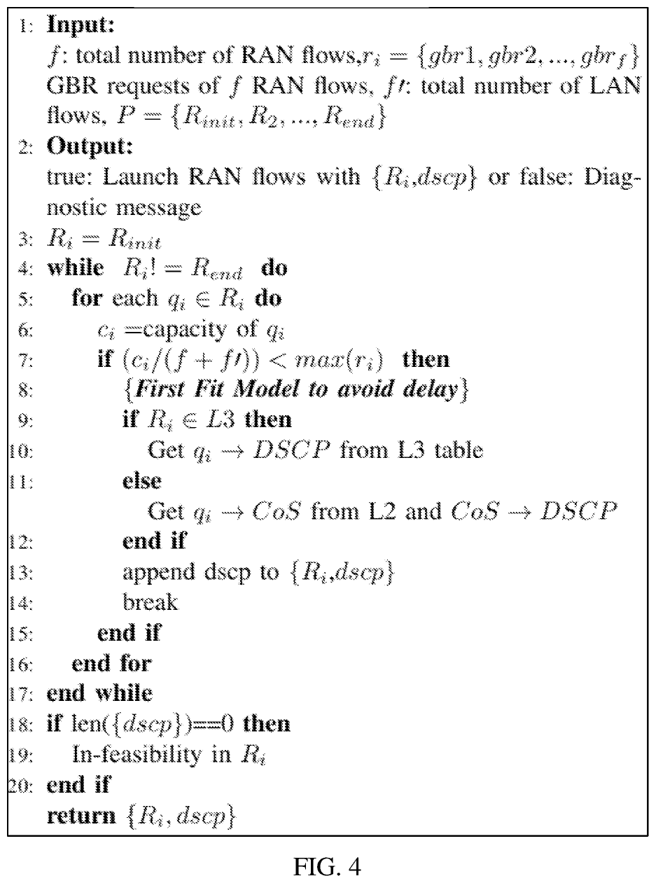

Referring now to FIG. 4, pseudo-code is provided that implements a feasibility check for a network path. The queues qᵢ of the LAN devices Rᵢ are evaluated for their respective capacities and DSCP information is gathered. If the route node for the RAN flow has a layer 3 switch, then the DSCP value for the RAN flow may be taken from the switch's table. This is because layer 3 switches are often used to route traffic between different networks and need to differentiate between types of traffic to ensure that it is routed efficiently.

The layer 3 switch's table may include a mapping between RAN flows and DSCP values. This mapping is used by the switch to determine how to treat different types of traffic. If the route node for the RAN flow does not have a layer 3 switch, then the class of service value from the layer 2 switch for the RAN Flow is used. The class of service value may be a three-bit value used to classify traffic on layer 2 switches, and may be used to determine the DSCP value for the RAN flow.

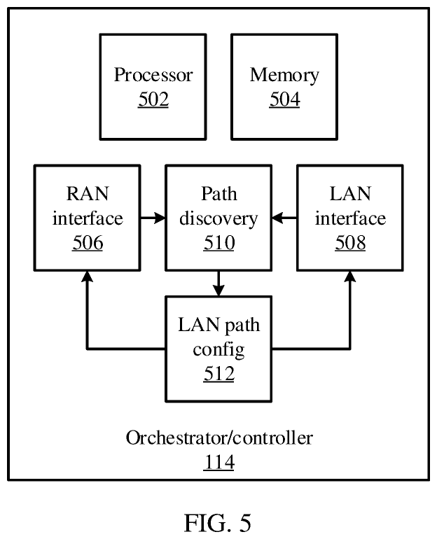

Referring now to FIG. 5, additional detail on the orchestrator/controller 114 is shown. The orchestrator/controller 114 may be a device that is separate from the RAN 108 and LAN 110 but that communicates with elements of each. The orchestrator/controller 114 may be may be implemented as a part of a router or switch in the RAN 108 or the LAN 110. In standalone embodiments, the orchestrator/controller 114 may include a separate hardware processor 502 and memory 504.

The orchestrator 114 includes a RAN interface 506 that communicates with devices of the RAN 108 and a LAN interface 508 that communicates with devices of the LAN 110. These interfaces may implement any appropriate wired or wireless communications protocol and medium. In some cases, the functions of the RAN interface 506 and the LAN interface 508 may be performed by a single hardware device.

Information from the RAN interface 506, relating to network slices and QoS assurances in the RAN 108, as well as information from the LAN interface, relating to the status and configuration of the devices and traffic in the LAN 110, are collected at path discovery 510 to identify a network path through the LAN 110 that can accommodate a flow from the RAN 108. LAN path config 512 performs any needed changes to the configuration of devices within the LAN 110 and coordinates the traffic flow across an edge router between the RAN 108 and the LAN 110.

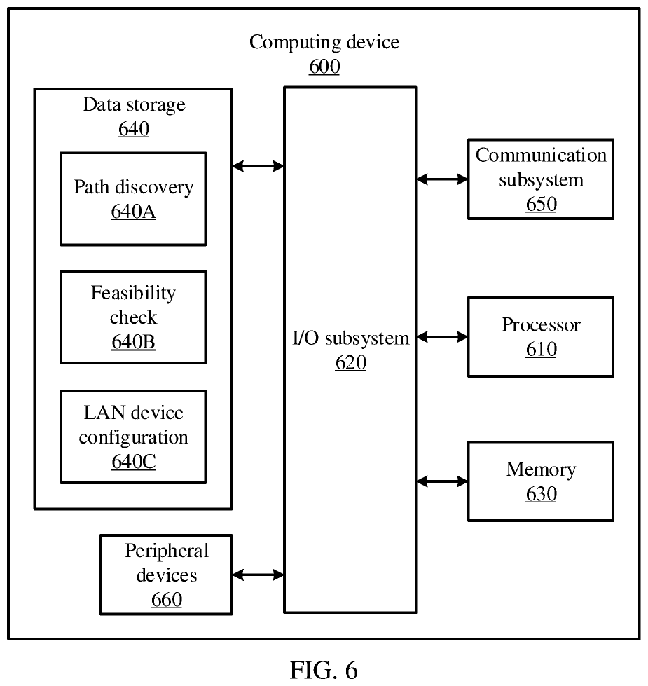

Referring now to FIG. 6, an exemplary computing device 600 is shown, in accordance with an embodiment of the present invention. The computing device 600 is configured to perform classifier enhancement.

The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for performing path discovery, 640B for feasibility checks, and/or 640C for LAN device configuration. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for transmission over a heterogeneous network, comprising:
determining a path through a first network, including collecting quality of service (QoS) parameters for network devices in the path;
configuring the QoS parameters of the network devices to provide a predetermined QoS assurance across the path; and
transmitting a network flow from a network slice of a second network through the first network, along the path.

2. The method of claim 1, wherein the QoS parameters include differentiated services code point (DSCP) values for queues of the network devices.

3. The method of claim 2, wherein configuring the QoS parameters includes installing a rewrite function at one or more of the network devices.

4. The method of claim 3, wherein the rewrite function modifies DSCP values of incoming packets.

5. The method of claim 1, wherein configuring the QoS parameters includes reserving ports responsive to network traffic in the first network.

6. The method of claim 5, wherein reserving ports responsive to network traffic includes reserving ports according to a two-rate three-color approach.

7. The method of claim 1, wherein configuring the QoS parameters includes setting a queue draining policy to be round-robin for the network devices.

8. The method of claim 1, wherein determining the path includes gathering a class of service from at least one layer 2 switch.

9. The method of claim 1, wherein the second network is a radio access network that receives traffic from a wireless device and the second network is a local area network (LAN) that includes a target device for the network flow.

10. The method of claim 1, wherein the network slice of the second network has an associated QoS guarantee that corresponds to the predetermined QoS assurance across the path.

11. A system for transmission over a heterogeneous network, comprising:
a hardware processor; and
a memory that stores a computer program which, when executed by the hardware processor, causes the hardware processor to:
determine a path through a first network, including collecting quality of service (QoS) parameters for network devices in the path;
configure the QoS parameters of the network devices to provide a predetermined QoS assurance across the path; and
transmit a network flow from a network slice of a second network through the first network, along the path.

12. The system of claim 11, wherein the QoS parameters include differentiated services code point (DSCP) values for queues of the network devices.

13. The system of claim 12, wherein the computer program further causes the hardware processor to install a rewrite function at one or more of the network devices.

14. The system of claim 13, wherein the rewrite function modifies DSCP values of incoming packets.

15. The system of claim 11, wherein the computer program further causes the hardware processor to reserve ports responsive to network traffic in the first network.

16. The system of claim 15, wherein the computer program further causes the hardware processor to reserve ports according to a two-rate three-color approach.

17. The system of claim 11, wherein the computer program further causes the hardware processor to set a queue draining policy to be round-robin for the network devices.

18. The system of claim 11, wherein the computer program further causes the hardware processor to gather a class of service from at least one layer 2 switch.

19. The system of claim 11, wherein the second network is a radio access network that receives traffic from a wireless device and the second network is a local area network (LAN) that includes a target device for the network flow.

20. The system of claim 11, wherein the network slice of the second network has an associated QoS guarantee that corresponds to the predetermined QoS assurance across the path.
